(19) United States
(12) Patent Application Publication
(10) Pub. No.: US 2004/0095858 A1
(43) Pub. Date: May 20, 2004

(54) Method and apparatus for ocntrolling objective lens to prevent disc from being scratched by the objective lens

(76) Inventors: Byoung-Ho Choi, Gyoonggi-do (KR); Soo-yul Jung, Gyeonggi-do (KR); Byung-in Ma, Gyeonggi-do (KR); In-sik Park, Gyeonggi-do (KR)

Correspondence Address: STAAS & HALSEY LLP, SUITE 700, 1201 NEW YORK AVENUE, N.W., WASHINGTON, DC, 20005, US

(21) Appl. No.: 10/627,973

(22) Filed: Jul. 28, 2003

(30) Foreign Application Priority Data
Jul. 29, 2002 (KR) 2002-44629

(51) Int. Cl. G11B 7/00

(52) U.S. Cl. 369/44.29

(57) ABSTRACT

A method and apparatus preventing a disc from being scratched by an objective lens. A focus pull-in operation is performed. If a level of a pull-in signal remains lower than a predetermined critical level for a predetermined critical period of time or more, the objective lens is controlled so as to move away from the disc.

### CROSS-REFERENCE TO RELATED APPLICATION

This application claims the benefit of Korean Patent Application No. 2002-44629, filed on Jul. 29, 2002 in the Korean Intellectual Property Office, the disclosure of which is incorporated herein by reference.

### BACKGROUND OF THE INVENTION

1. Field of the Invention

The present invention relates to a method and apparatus for controlling an objective lens to prevent a disc from being scratched by the objective lens.

2. Description of the Related Art

An objective lens having a large numerical aperture (NA) and a laser diode having a short wavelength have been recently used to increase recording density of an optical disc in an optical disc system. When NA increases and wavelength decreases, the focal distance becomes short. Thus, an objective lens easily brushes up against an optical disc, even by a small disturbance, and scratches the optical disc. Since next generation high-density optical discs such as blue discs (BD) aim to have a recording density about five times as high as DVDs, they use an objective lens having a large NA and a blue laser having a short wavelength. Due to this, the possibility that the objective lens will scratch the next generation high-density optical discs is high. In a case of a portable system, a distance between an optical disc and an objective lens is even shorter and physical disturbances are more frequent and severe. Thus, the possibility of the objective lens scratching the optical disc increases.

### SUMMARY OF THE INVENTION

The present invention provides a method and apparatus for controlling an objective lens so as to prevent an optical disc from being scratched by the objective lens in an optical disc system.

The present invention also provides a method and apparatus for controlling an objective lens so as to prevent an optical disc from being scratched by the objective lens in a mobile optical disc system.

According to an aspect of the present invention, a method of preventing a disc from being scratched by an objective lens is provided. A focus pull-in operation is performed. If a level of a pull-in signal remains lower than a predetermined critical level for a predetermined critical period of time or more, the objective lens is controlled so as to move away from the disc.

According to another aspect of the present invention, the predetermined critical period of time is set to a time for which the objective lens may remain dangerously close to the disc when an actuator for actuating the pickup moves at an actual maximum speed.

According to an aspect of the present invention, in controlling the objective lens, a direct current signal is applied to the actuator for actuating the pickup having the objective lens.

According to another aspect of the present invention, a method of preventing a disc from being scratched by an objective lens is provided. A pull-in signal is initialized. A focus pull-in is performed. A level of the pull-in signal is checked. If the level of the pull-in signal is lower than a predetermined critical level, a time for which the level of the pull-in signal remains lower than the predetermined critical level is checked. If the time is a predetermined critical period of time or more, a pickup having the objective lens is controlled to move away from the disc.

If the time is not equal to, or greater than the predetermined critical period of time, an actuator for actuating the pickup having the objective lens is left as it is. If the time is not equal to, or greater than the predetermined critical period of time, an average value of a drive signal that was previously applied is output to the actuator for actuating the pickup having the objective lens.

According to still another aspect of the present invention, an apparatus for preventing a disc from being scratched by an objective lens is provided. The apparatus includes a pickup, an actuator, a signal detector, and a controlling unit. The pickup has an objective lens. The actuator actuates the pickup. The signal detector detects a pull-in signal from the pickup. If a level of the pull-in signal is maintained lower than a predetermined critical level for a predetermined critical period of time or more, the controlling unit controls the actuator so that the objective lens moves away from the disc.

Additional aspects and advantages of the invention will be set forth in part in the description which follows and, in part, will be obvious from the description, or may be learned by practice of the invention.

### BRIEF DESCRIPTION OF THE DRAWINGS

These features and/or other aspects and advantages of the invention will become apparent and more readily appreciated from the following description of the embodiments taken in conjunction with accompanying drawings in which:

FIG. 1 is a schematic view of an apparatus for preventing an optical disc from being scratched by an objective lens according to an embodiment of the present invention;

FIG. 2 is a detailed view of a pickup shown in FIG. 1;

FIGS. 3A-3C are graphs explaining a method of preventing an optical disc from being scratched by an objective lens according to an embodiment of the present invention;

FIGS. 4A-4C are graphs explaining a method of preventing an optical disc from being scratched by an objective lens according to another embodiment of the present invention;

FIGS. 5A-5C are graphs explaining a method of preventing an optical disc from being scratched by an objective lens according to still another embodiment of the present invention;

FIG. 6 is a flowchart of a method of preventing an optical disc from being scratched by an objective lens according to an embodiment of the present invention;

FIG. 7 is a flowchart of a method of preventing an optical disc from being scratched by an objective lens according to another embodiment of the present invention;

FIGS. 8A-8C and 9A-9C illustrate signals measured in executing a method of preventing an optical disc from being scratched by an objective lens according to one aspect of the present invention using an optical disc system having a pickup in which a laser diode having a NA of 0.7 and a wavelength of 500 nm or less is installed.

### DETAILED DESCRIPTION OF THE INVENTION

Reference will now be made in detail to the embodiments of the present invention, examples of which are illustrated in the accompanying drawings wherein like reference numerals refer to the like elements throughout. The embodiments are described below in order to explain the present invention by referring to the figures.

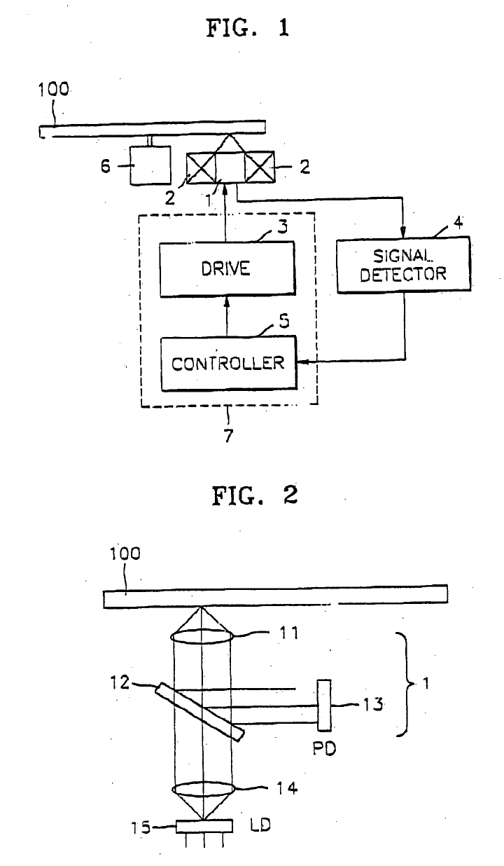

FIG. 1 is a block diagram of an apparatus preventing an optical disc from being scratched by an objective lens according to an embodiment of the present invention. Referring to FIG. 1, the apparatus includes a pickup 1, an actuator 2, a signal detector 4, and a controlling unit 7. The controlling unit 7 has a drive 3 and a controller 5. Reference numeral 6 denotes a spindle motor that rotates a disc 100.

The pickup 1 has an objective lens (not shown) that focuses a laser beam onto the disc 100. The actuator 2 actuates the pickup 1. The signal detector 4 detects a pull-in signal from a signal output from a photodiode (not shown) installed in the pickup 1. The controller 5 checks a level of the pull-in signal detected by the signal detector 4, and if the level of the pull-in signal is lower than, or equal to a predetermined critical level for at least a predetermined critical period of time, outputs to the drive 3 a control signal for controlling the objective lens to move away from the disc 100. The drive 3 outputs a drive signal corresponding to the control signal to the actuator 2. In other words, the drive 3 outputs a DC signal having a high level to the actuator 2 so as to move the pickup 1 away from the disc 100, and stops the actuator 2.

The critical time is set to a time for which the objective lens should not contact the disc 100 when the actuator 2 moves at a maximum speed. The critical level is set to a value measured at a level for which the objective lens in the pickup I should not contact the disc 100 when the pickup 1 moves toward the disc 100 during focus control due to a disturbance.

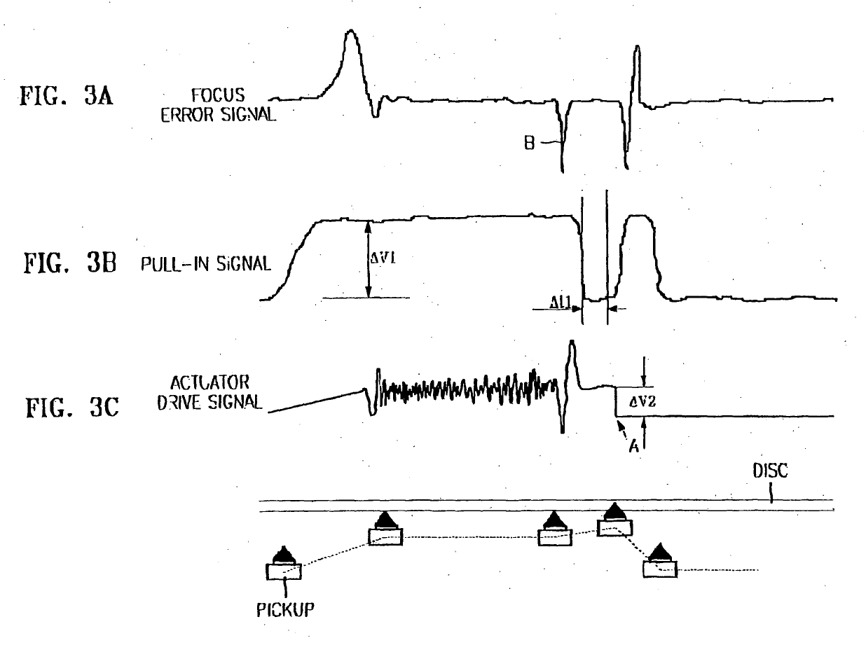

FIG. 2 is a detailed view of the pickup 1 shown in FIG. 1. Referring to FIG. 2, the pickup 1 includes a laser diode (LD) 15, a collimating lens 14, an objective lens 11, a beam splitter 12, and a photodiode (PD) 13.

The LD 15 radiates a laser beam. The collimating lens 14 focuses a divergent beam into a parallel laser beam. The objective lens 11 focuses the laser beam onto a reflective surface of the disc 100. The focused laser beam is incident on and reflected from a recording surface of the disc 100. The beam splitter 12 splits the laser beam into an incident laser beam and a reflected laser beam and changes an optical path so that the reflected laser beam travels toward the PD 13. The PD 13 is a light-receiving device that receives the reflected laser beam and includes a plurality of division light receiving units. If the number of division light receiving units is two, the PD 13 is called a 2-division PD. If the number of division light receiving units is 4, the PD 13 is called a 4-division PD. If the number of division light receiving units is 8, the PD 13 is called an 8-division PD.

According to one aspect of the present invention, the pull-in signal refers to a sum signal of signals focused onto the plurality of division light receiving units of the PD 13 or such a sum signal that is filtered through a low-pass filter to remove high-frequency components. A focus error signal, necessary for control so that the laser beam is properly focused on the recording surface of the disc 100, is also generated from the signals focused onto the plurality of division light receiving units of the PD 13.

Components of the pickup 1 and the layout thereof are independent of the characteristics of an aspect of the present invention. Thus, the elements shown in FIG. 2 and their structures may be modified. However, according to one aspect of the present invention, the PD 13 is an indispensable element to generate the pull-in signal. The PD 13 may be arranged in various positions in consideration of the remaining elements.

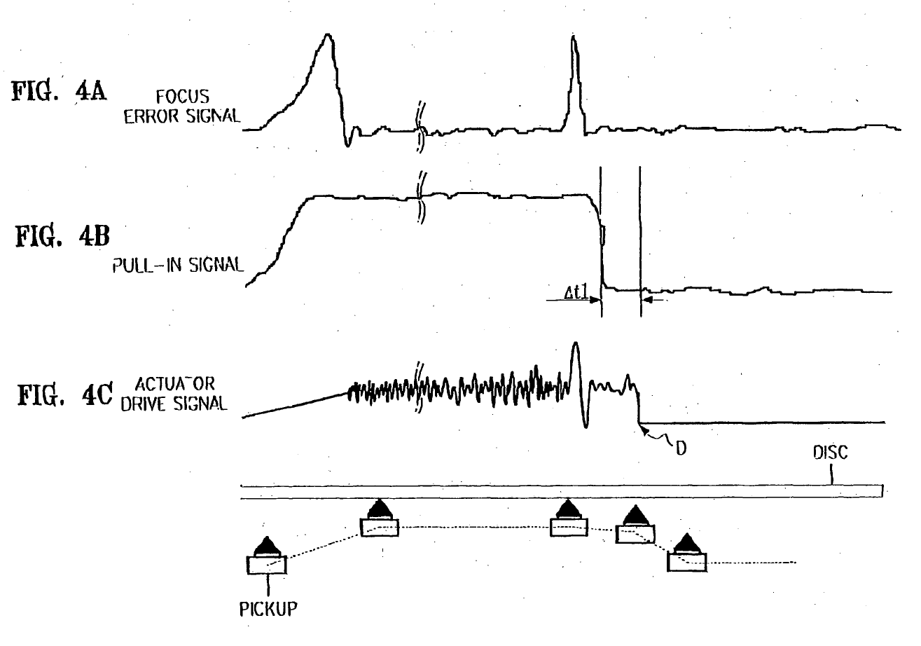

FIGS. 3A-3C are graphs explaining a method of preventing an optical disc from being scratched by an objective lens according to an embodiment of the present invention. As can be seen in FIGS. 3A-3C, a focus error signal, a pull-in signal, and an actuator drive signal are generated while the pickup 1 moves so that the pickup 1 moves away from the disc 100 when the objective lens 11 moves near enough to the disc 100 to scratch the disc 100 during a focus pull-in operation of the pickup 1.

When the laser beam is focused onto the recording surface of the disc 100, i.e., when the focus pull-in operation is performed, a level of the pull-in signal rises by an amount ΔV1 from an initial level to a predetermined DC level. When the pickup 1 is disturbed during the focus pull-in operation, the pickup 1 approaches the disc 100 abruptly. Then, the focus error signal at a predetermined DC level drops to a new level, generating a partial waveform B. Next, the pull-in signal drops to a level lower than a critical level according to one aspect of the present embodiment, i.e., to the initial level. If the pull-in signal stays at the initial level for a predetermined period of time Δt1 or longer, the pickup 1 continues moving toward the disc 100 and the objective lens 11 may impact against the disc 100. Therefore, before the objective lens 11 of the pickup 1 contacts the disc 100, a strong DC current is applied to the actuator 2 to force the pickup 1 to move away from the disc 100. The actuator drive signal stays at a DC level which drops by a predetermined amount ΔV2 at a point of time A occurring after the predetermined period of time Δt1. After the pickup 1 moves away from the disc 100, the pickup 1 stops. Thus, the pull-in signal rises again, and then falls to the initial level.

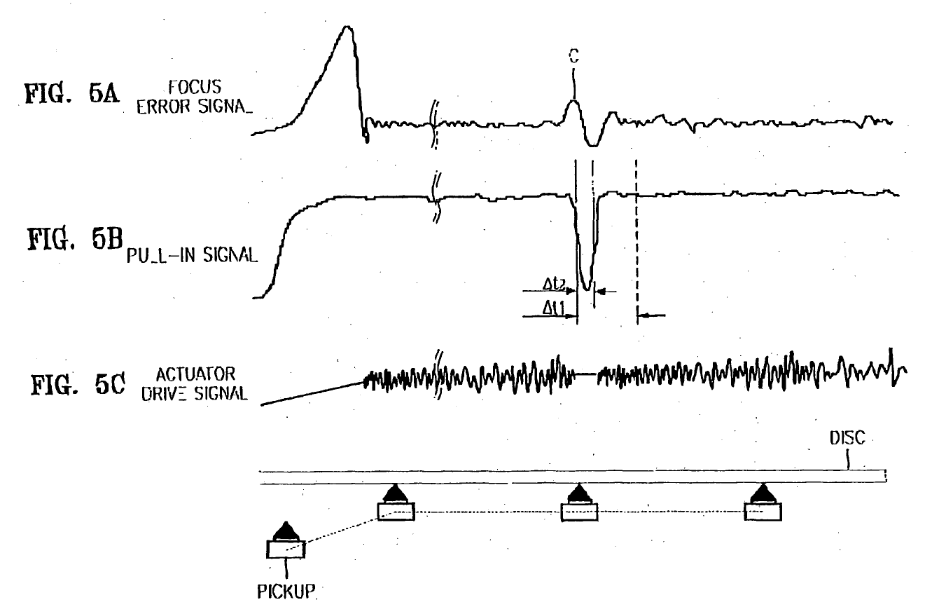

FIGS. 4A-4C are graphs explaining a method of preventing an optical disc from being scratched by an objective lens according to another embodiment of the present invention. As can be seen in FIGS. 4A-4C, a focus error signal, a pull-in signal, and an actuator signal are generated when the objective lens 11 moves away from the disc 100 during the focus pull-in operation of the pickup 1 due to a disturbance.

When the laser beam is focused onto the recording surface of the disc 100, i.e., when the focus pull-in operation is performed, the pull-in signal rises from an initial level to a predetermined DC level. If the pickup 1 suddenly moves away from the disc 100 during the focus pull-in operation due to a disturbance, the focus error signal, which was at the predetermined DC level, rises upward. The pull-in signal drops to a level lower than a critical level according to one aspect of the present embodiment, i.e., to the initial level. When the pull-in signal drops to the initial level, and then stays there for a predetermined period of time Δt1 or longer, the pickup 1 gets out of focus, and the objective lens 11 may impact against the disc 100 at any time. Thus, a strong DC current is applied to the actuator 2 to move the pickup 1 away from the disc 100, and stop the pickup 1. The strong DC current is applied to the actuator 2 until the pickup 1 stops. The actuator drive signal stays at a DC level which drops by a predetermined amount at time D after the predetermined period of time Δt1. Since the pickup 1 stops after moving away from the disc 100, the pull-in signal stays at the initial level.

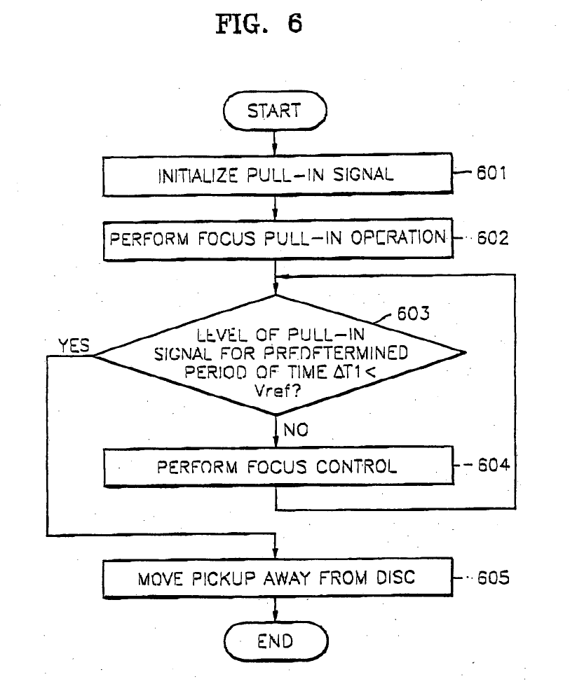

FIGS. 5A-5C are graphs explaining a method of preventing an optical disc from being scratched by an objective lens according to still another embodiment of the present invention.

As can be seen in FIGS. 5A-5C are graphs, a focus error signal, a pull-in signal, and an actuator drive signal are generated when a laser beam spot passes through a portion of the disc 100 on which scratches, black dots or the like are formed during the focus pull-in operation of the pickup 1.

When the laser beam is focused onto the recording surface of the disc 100, i.e., when the focus pull-in operation is performed, the pull-in signal rises by Δt1 from an initial level to a predetermined DC level. When the laser beam spot passes through a portion of the disc 100 on which scratches, black dots or the like are formed during the focus pull-in operation of the pickup 1, the focus error signal stays at a predetermined DC level, rises up, falls and then levels off, creating a partial waveform C. However, the level of the partial waveform C, shown in FIG. 5A, is lower than the level of the waveform shown in FIG. 3A and the partial waveform C, shown in FIG. 5A is sinusoidal in shape. Next, the pull-in signal drops to a level lower than a critical level according to the present embodiment, i.e., to the initial level. However, the pull-in signal does not stay at the initial level for at least a predetermined critical period of time Δt1. Instead, after a predetermined period of time Δt2 which is shorter than the predetermined critical period of time Δt1, the pull-in signal returns to the previous DC level. This indicates that the pickup 1 does not move toward the disc 100. Thus, the drive 3 does not perform any operations or the drive 3 outputs to the actuator 2 the signal that was previously applied to the actuator 2, i.e., an average value of the actuator drive signal.

Methods of preventing a disc from being scratched will be described using the above-described structure for aid of illustration, the methods not being dependent on a particular structure.

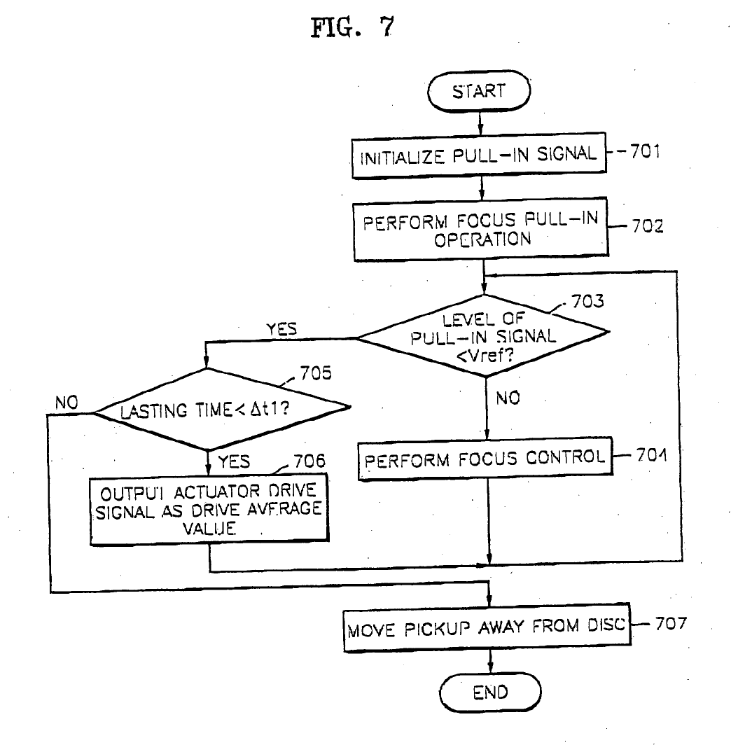

FIG. 6 is a flowchart of a method of preventing an optical disc from being scratched by an objective lens according to an embodiment of the present invention.

In operation 601, the controlling unit 7 sets an initial value after turning off the LD 15 or moving the pickup 1 to a position where a laser beam emitted from the objective lens 11 is reflected from the recording surface of the disc 100 and is not incident on the PD 13. The initial value is set to a value for easily checking changes in the level of the pull-in signal in various situations as described with reference to FIGS. 3A-3C, 4A-4C, and 5A-5C. In operation 602, the controlling unit 7 performs focus control so that a spot of a laser beam is exactly focused onto the recording surface of the disc 100. In other words, the controlling unit 7 carries out a focus pull-in operation. If the focus pull-in operation is completed, the intensity of light focused onto the PD 13 is a maximum. Thus, a pull-in signal obtained in this state has a proper DC level. Therefore, the level of the pull-in signal can be measured to check whether the focus pull-in operation has been properly performed. The pull-in signal stays at a predetermined DC level while the spot of the laser beam is exactly focused.

In operation 603, the controlling unit 7 checks whether the level of the pull-in signal becomes lower than a predetermined critical level Vref and remains below the critical level for a predetermined critical period of time Δt1.

If the level of the pull-in signal is not lower than the predetermined critical level for the predetermined critical period of time Δt1, in operation 604, the controlling unit 7 determines that the pickup 1 is not moving toward the disc 100, and then performs focus control continuously.

If the level of the pull-in signal is lower than the predetermined critical level Vref for the predetermined critical period of time Δt1, in operation 605, the controlling unit 7 determines that the pickup 1 is moving toward the disc 100, and then outputs to the actuator 2 an actuator drive signal for moving the pickup 1 away from the disc 100 or for stopping the pickup 1 after moving the pickup 1.

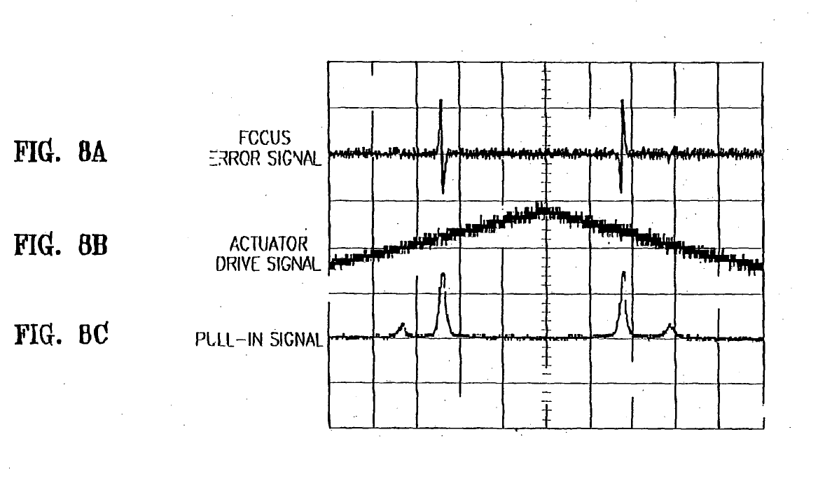

FIG. 7 is a flowchart of a method of preventing an optical disc from being scratched by an objective lens according to another embodiment of the present invention. Referring to FIG. 7, in operation 701, the controlling unit 7 sets an initial value of a pull-in signal when turning off the LD 15 or moving the pickup 1 to a position where a laser beam emitted from the objective lens 11 is reflected from the recording surface of the disc 100 and is not incident on the PD 13. The initial value is set to a value for easily checking changes in the level of the pull-in signal in various situations as described with reference to FIGS. 3A-3C, 4A-4C, and 5A-5C. In operation 702, the controlling unit 7 performs focus control so that a spot of a laser beam is exactly focused onto the recording surface of the disc 100. In other words, the controlling unit 7 carries out a focus pull-in operation. If the focus pull-in operation is completed, the intensity of light focused onto the PD 13 is the highest. Thus, a pull-in signal obtained in this state has a proper DC level. Therefore, the level of the pull-in signal can be measured to check whether the focus pull-in operation has been properly performed. The pull-in signal stays at a predetermined DC level while the spot of the laser beams is exactly focused.

In operation 703, the controlling unit 7 checks whether the level of the pull-in signal becomes lower than a predetermined critical level Vref. If the level of the pull-in signal does not become lower than the predetermined critical level Vref, in operation 704, the controlling unit 7 continues performing the focus control.

If the level of the pull-in signal becomes lower than the predetermined critical level Vref, in operation 704, the controlling unit 7 checks whether the level of the pull-in signal stays there for a predetermined critical period of time Δt1 or more. If the level of the pull-in signal becomes lower than the predetermined critical level Vref but does not stay there for the predetermined critical period of time Δt1, in operation 706, the controlling unit 7 determines that the pickup 1 does not move toward the disc 100, and then outputs to the actuator 2 an average value of a drive signal that was previously output to the actuator 2, i.e., a drive average value.

If the level of the pull-in signal remains lower than the predetermined critical level Vref for the predetermined critical period of time Δt1 or more, in operation 707, the controlling unit 7 determines that the pickup 1 is moving toward the disc 100, and then outputs to the actuator 2 the drive signal for moving the pickup 1 away from the disc 100 or for stopping the pickup 1 after moving the pickup 1.

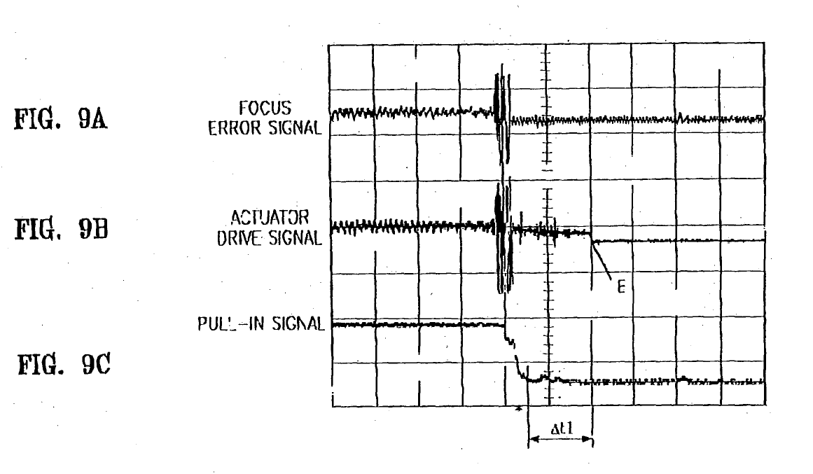

FIGS. 8A-8C and 9A-9C illustrate signals measured for executing a method of preventing an optical disc from being scratched by an objective lens according to an aspect of the present invention using an optical disc system having a pickup in which a laser diode having a NA of 0.7 or more and a wavelength of 500 nm or less is installed.

Referring to FIGS. 8A-8C, an actuator drive signal for actuating the actuator 2, a focus error signal, and a pull-in signal are generated so that the pickup 1 is close to and away from the disc 100, i.e., the pickup 1 moves up and down. While focus control is performed, i.e., a focus pull-in operation, is performed, the pull-in signal is maintained at a predetermined DC level.

Referring to FIGS. 9A-9C, an actuator drive signal, a focus error signal, and a pull-in signal are generated when a method of preventing a disc from being scratched by an objective lens according to the present invention is executed. The pull-in signal stays at a predetermined DC level, drops to an initial level, and then stays at the initial level for a predetermined critical period of time Δt1. Then, the actuator drive signal stays at a predetermined DC level from a point of time E after the predetermined critical period of time Δt1 so that the pickup 1 is distant from the disc 100. Thus, the pickup 1 stops after moving so that the pickup 1 is distant from the disc 100.

As described above, the aspects of the present invention provide a method and apparatus for controlling an objective lens to prevent a disc from being scratched by the objective lens by properly coping with a situation where the objective lens moves close to the disc during a focus pull-in operation due to a disturbance and scratches the disc. In particular, an aspect of the present invention is very effective in a high-density recording system in which an objective lens (or a pickup) moves close to a disc during a focus pull-in operation due to the short focal distance or a mobile optical disc system in which disturbances are frequent and sometimes severe.

According to another aspect of the invention, the controlling unit 7 includes a computer implementing the methods in FIGS. 6 and 7 using data encoded on a computer readable medium.

Although a few embodiments of the present invention have been particularly shown and described, it would be appreciated by those skilled in the art that changes may be made therein in these embodiments without departing from the principles and spirit of the invention, the scope of which is defined in the claims their equivalents.

What is claimed is:

1. A method of preventing a disc from being scratched by an objective lens, the method comprising:
performing a focus pull-in operation; and
if a level of a pull-in signal remains lower than a predetermined critical level for at least a predetermined critical period of time, controlling the objective lens so as to move away from the disc.

2. The method of claim 1, wherein the predetermined critical period of time is set to a time for which the objective lens remains a minimum distance from the disc without damaging the disc when an actuator actuating a pickup moves at an operational maximum speed.

3. The method of claim 1, wherein the controlling the objective lens comprises applying a direct current signal to the actuator for actuating a pickup having the objective lens.

4. The method of claim 3, wherein the direct current signal is applied to stop the actuator.

5. The method of claim 1, wherein the pull-in signal is one of a sum signal of signals focused onto a plurality of division light-receiving units of a photodiode and a signal generated by filtering a sum signal through a low-pass filter.

6. A method of preventing a disc from being scratched by an objective lens, the method comprising:
initializing a pull-in signal;
performing a focus pull-in;
checking a level of the pull-in signal;
if the level of the pull-in signal is lower than a predetermined critical level, checking a time for which the level of the pull-in signal remains lower than the predetermined critical level; and
if the time is at least a predetermined critical period of time, controlling a pickup having the objective lens to move away from the disc.

7. The method of claim 6, further comprising:
if the time is not at least the predetermined critical period of time, outputting an average value of a drive signal that was previously applied to the actuator for actuating a pickup having the objective lens.

8. The method of claim 6, wherein the initializing of the pull-in signal comprises initializing the pull-in signal to a level lower than a predetermined direct current level so as to easily detect the predetermined direct current level during the focus pull-in operation.

9. The method of claim 6, wherein, the predetermined critical period of time is set to a time for which the objective lens remains a minimum distance from the disc without damaging the disc when the actuator moves at an operational maximum speed.

10. The method of claim 6, wherein, if the time is at least predetermined critical period of time, applying a direct current signal to the actuator.

11. The method of claim 10, wherein the direct current signal is applied to stop the actuator.

12. The method of claim 6, wherein the pull-in signal is one of a sum signal of signals focused onto a plurality of division light receiving units of a photodiode and a signal generated by filtering a sum signal through a low-pass filter.

13. An apparatus preventing a disc from being scratched by an objective lens, the apparatus comprising:
a pickup having an objective lens;
an actuator actuating the pickup;
a signal detector detecting a pull-in signal from the pickup; and
a controlling unit that if a level of the pull-in signal is maintained lower than a predetermined critical level for at least a predetermined critical period of time, controls the actuator so that the objective lens moves away from the disc.

14. The apparatus of claim 13, wherein the predetermined critical period of time is set to a time for which the objective lens remains a minimum distance from the disc without damaging the disc when the actuator moves at an operational maximum speed.

15. The apparatus of claim 13, wherein the controlling unit applies a direct current signal to the actuator.

16. The apparatus of claim 13, wherein the controlling unit applies a direct current signal to the actuator so as to stop the actuator.

17. The apparatus of claim 13, wherein the pull-in signal is one of a sum signal of signals focused onto a plurality of division light receiving units of a photodiode and a signal generated by filtering a sum signal through a low-pass filter.

18. The method according to claim 1, wherein the predetermined critical level is set to a value measured at a level for which an objective lens in a pickup should not contact a disc when the pickup moves toward the disc during focus control due to a disturbance.

19. The method according to claim 6, wherein the predetermined critical level is set to a value measured at a level for which an objective lens in a pickup should not contact a disc when the pickup moves toward the disc during focus control due to a disturbance.

20. The apparatus according to claim 13, wherein the predetermined critical level is set to a value measured at a level for which the objective lens in the pickup should not contact the disc when the pickup moves toward the disc during focus control due to a disturbance.

21. A computer readable medium encoded with processing instructions implementing a method of preventing a disc from being scratched by an objective lens, the method comprising:
performing a focus pull-in operation; and
controlling the objective lens so as to move away from the disc if a level of a pull-in signal remains lower than a predetermined critical level for a predetermined critical period of time or more.

22. The computer readable medium of claim 21, wherein the predetermined critical period of time is set to a time for which the objective lens remains a minimum distance from the disc without damaging the disc when an actuator actuating the pickup moves at an operational maximum speed.

23. The computer readable medium of claim 21, wherein a direct current signal is applied to the actuator for actuating a pickup having the objective lens.

24. The computer readable medium of claim 21, wherein the pull-in signal is one of a sum signal of signals focused onto a plurality of division light receiving units of a photodiode and a signal generated by filtering a sum signal through a low-pass filter so as to remove a high frequency component.

25. A computer readable medium encoded with processing instructions implementing a method of preventing a disc from being scratched by an objective lens, the method comprising:
initializing a pull-in signal;
performing a focus pull-in;
checking a level of the pull-in signal;
checking a time for which the level of the pull-in signal remains lower than the predetermined critical level if the level of the pull-in signal is lower than a predetermined critical level; and
controlling a pickup having the objective lens so as to move away from the disc if the time is at least a predetermined critical period of time.

26. An apparatus preventing a disc from being scratched by an objective lens, the apparatus comprising:
a pickup;
an actuator actuating the pickup;
a signal detector detecting a pull-in signal from the pickup; and
a controller checking levels of a detected signal and outputting a control signal; and
a drive moving the pickup based on the control signal.

27. The apparatus of claim 26, the pickup comprising:
a laser diode radiating a beam of light;
a collimating lens focusing the beam of light into a parallel beam of light;
an objective lens focusing the parallel beam onto the disc;
a beam splitter splitting the beam of light into an incident beam of light and a reflected beam of light and changing the path of the reflected beam of light; and
a photodiode receiving the reflected beam of light.

28. The apparatus of claim 27, the laser diode having a NA of at least 0.7, and a wavelength of 500 nm or less.

29. A method of controlling a movement of a pickup, comprising:
radiating a laser beam from the pickup;
focusing the laser beam onto a surface of a reflective disc;
receiving a reflected beam of light from the disc with a plurality of light- receiving units;
generating a focus pull-in signal and a focus error signal based on the received light;
checking a level of the generated focus pull-in signal and focus error signals; and
generating a current based on the level of the signals so as to move the pickup.

30. The method of controlling a movement of a pickup of claim 28, wherein checking a level includes checking when the focus pull-in signal drops to an initial level for a predetermined period of time.

31. A method of controlling a movement of a pickup, comprising:
setting an initial value of a pickup pull-in signal;
focusing a laser beam from the pickup on a disc based on an initial value of the pulling signal;
checking a level of the pull-in signal; and
outputting a drive signal for the pickup based on the level of the pull-in signal.

32. The method of controlling a movement of a pickup as claimed in claim 31, wherein checking a level of the pull-in signal includes checking whether the pull-in signal is lower than a predetermined level for at least a predetermined critical period of time.
